(19) United States
(12) Patent Application Publication
(10) Pub. No.: US 2014/0290628 A1
(43) Pub. Date: Oct. 2, 2014

(54) SYSTEM WITH LIQUID CONTAINMENT TANK INCLUDING AN IN-LINE LIQUID VAPOR DISCRIMINATING VALVE EXTERNAL TO THE TANK

(71) Applicant: Eaton Corporation, Cleveland, OH (US)

(72) Inventors: Vaughn Kevin Mills, Chelsea, MI (US); Matthew Lorenz Erdmann, Galesburg, MI (US)

(73) Assignee: Eaton Corporation, Cleveland, OH (US)

(21) Appl. No.: 14/285,851

(22) Filed: May 23, 2014

Related U.S. Application Data
(63) Continuation-in-part of application No. 12/582,197, filed on Oct. 20, 2009.
(60) Provisional application No. 61/898,668, filed on Nov. 1, 2013.
(60) Provisional application No. 61/973,966, filed on Apr. 2, 2014.
(60) Provisional application No. 61/862,072, filed on Aug. 4, 2013.

(51) Int. Cl. F02M 25/08

(52) U.S. Cl. CPC F02M 25/08
USPC 123/518

(57) ABSTRACT

A system for containing liquid and venting vapor includes a liquid containment tank having an interior space. A first conduit is external to and operatively connected with the tank. The first conduit has a first internal passage fluidly communicable with the interior space. A second conduit is external to the tank, and has a second internal passage. A liquid vapor discriminating (LVD) valve is external to the tank and has a housing defining an inlet connected to the first conduit, an outlet connected to the second conduit, and an internal housing cavity. The valve includes a membrane filter positioned in the internal housing cavity between the inlet and the outlet. The membrane filter is configured to prevent the passage of liquid through the membrane and allow the passage of vapor through the membrane.

### CROSS-REFERENCE TO RELATED APPLICATIONS

This application is a continuation-in-part of U.S. application Ser. No. 12/582,197, filed Oct. 20, 2009, and claims the benefit of U.S. Provisional Application No. 61/862,072, filed Aug. 4, 2013, U.S. Provisional Application No. 61/898,668, filed Nov. 1, 2013, and U.S. Provisional Application No. 61/973,966, filed Apr., 2, 2014, all of which are hereby incorporated by reference in their entireties.

### TECHNICAL FIELD

The present teachings generally include tank venting systems, including fuel tank systems, with liquid discriminating and vapor permeable membranes.

### BACKGROUND

Proper venting and containment of fuel and fuel vapor is required for fuel tanks For example, motor vehicle fuel tanks are configured to contain liquid fuel and to vent fuel vapor in a controlled manner.

### SUMMARY

A system for containing liquid and venting vapor includes a liquid containment tank having an interior space. A first conduit is external to and operatively connected with the tank. The first conduit has a first internal passage fluidly communicable with the interior space. A second conduit is external to the tank, and has a second internal passage. A liquid vapor discriminating (LVD) valve is external to the tank and has a housing defining an inlet connected to the first conduit, an outlet connected to the second conduit, and an internal housing cavity. The LVD valve includes a membrane filter positioned in the internal housing cavity between the inlet and the outlet. The membrane filter is configured to prevent the passage of liquid through the membrane and allow the passage of vapor through the membrane. The LVD valve is referred to as an in-line liquid vapor discriminating valve as it is mounted external to the tank in the flow path of vapor from the tank, with the inlet and outlet connected to the first and second conduits. The tank can be a fuel tank for a vehicle. In another embodiment, the tank can be a urea tank for a vehicle.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic view of a vehicle fuel system employing a venting valve in accordance with an embodiment of the disclosure.

FIG. 2A is a partial perspective view of a venting valve of FIG. 1 including a membrane in accordance with an embodiment of the disclosure.

FIG. 2B is a cross-sectional view of a venting valve of FIG. 1 including a membrane in accordance with an embodiment of the disclosure.

FIGS. 2C and 2D are sectional views cut along plane 2C-2C on FIG. 2B.

FIG. 2E is a cross-sectional view of a venting valve of FIG. 1 including a housing in accordance with an embodiment of the disclosure.

FIG. 2F is perspective view of the housing of FIG. 2E in accordance with an embodiment of the disclosure.

FIGS. 3A-3B are top views of a membrane for a venting valve of FIG. 1 in accordance with another embodiment of the disclosure.

FIG. 3C is a side view of the membrane shown in FIGS. 3A-3B.

FIG. 4 is a side view of a membrane for a venting valve of FIG. 1 in accordance with another embodiment of the disclosure.

FIGS. 5A-5B are perspective views of a membrane for a venting valve of FIG. 1 in accordance with another embodiment of the disclosure.

FIG. 6 is a perspective view of a membrane for a venting valve of FIG. 1 in accordance with another embodiment of the disclosure.

FIG. 7 is a perspective view of a venting valve of FIG. 1 including a membrane in accordance with another embodiment of the disclosure.

FIG. 8 is another perspective view of the venting valve of FIG. 7.

FIG. 9 is a partial perspective view of the membrane of the venting valve of FIGS. 7-8 in accordance with an embodiment of the disclosure.

FIG. 10 is a partial perspective view of a membrane for a venting valve of FIG. 1 in accordance with another embodiment of the disclosure, including additional supporting structure for the membrane.

FIGS. 11A-11C are perspective views of a membrane for a venting valve of FIG. 1 in accordance with other embodiments of the disclosure.

FIG. 12 is a schematic partially cross-sectional and fragmentary illustration of a fuel system with an in-line liquid vapor discriminator trap taken at lines 12-12 in FIG. 13 constructed in accordance with one aspect of the disclosure.

FIG. 13 is a schematic plan view illustration of the in-line liquid vapor discriminator trap of FIG. 12.

FIG. 14 is a schematic partially cross-sectional and fragmentary illustration of a fuel system with an in-line liquid vapor discriminator trap taken at lines 14-14 in FIG. 16 constructed in accordance with another aspect of the disclosure.

FIG. 15 is a schematic fragmentary perspective illustration of the fuel system of FIG. 14.

FIG. 16 is a schematic perspective illustration of the in-line liquid vapor discriminator trap of FIG. 14.

FIG. 17 is a schematic perspective illustration of an alternative in-line liquid vapor discriminator trap for use with the fuel system of FIG. 12 or FIG. 14.

FIG. 18 is schematic perspective illustration of the in-line liquid vapor discriminator trap of FIG. 17 from another perspective.

FIG. 19 is a schematic illustration in end view of the in-line liquid vapor discriminator trap of FIG. 17.

FIG. 20 is a schematic illustration in side view of the in-line liquid vapor discriminator trap of FIG. 17.

### DETAILED DESCRIPTION

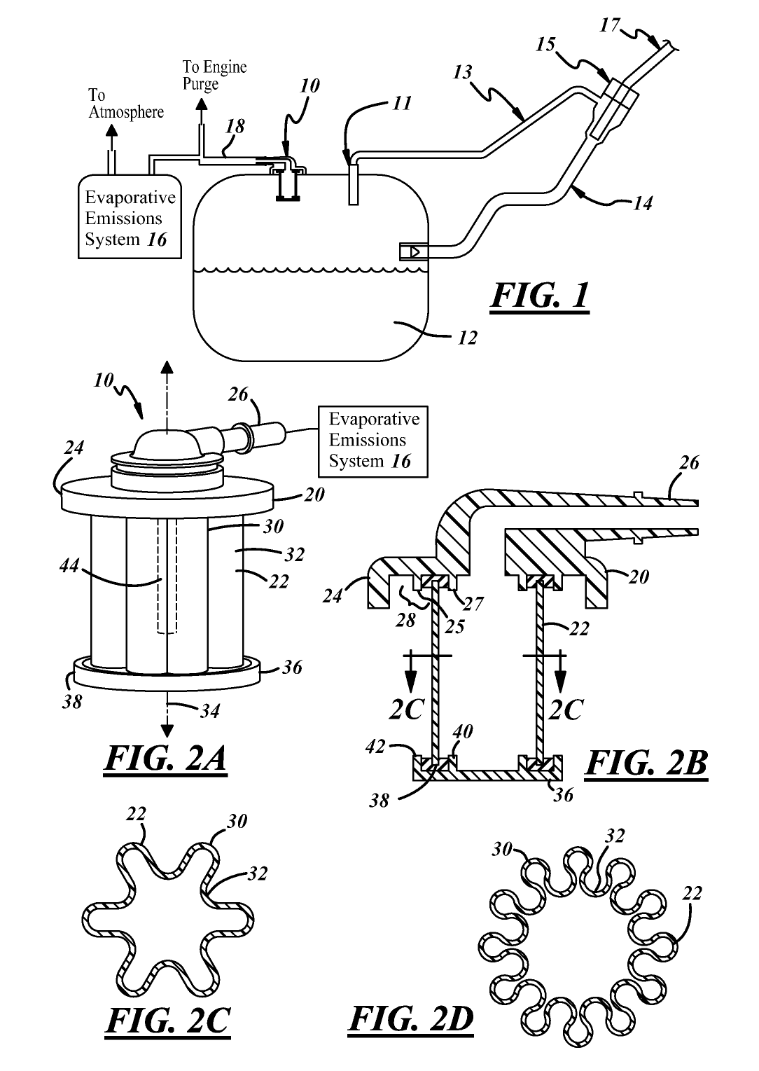

Referring to the drawings, wherein like reference numbers refer to like components throughout the views, FIG. 1 illustrates a schematic view of a vehicle fuel system. The vehicle fuel system may include a dip tube 11, a fuel tank 12, a recirculation line 13, a fill cup 15, and a refueling nozzle 17. The fuel tank 12 may contain liquid fuel. The vehicle fuel system may also include a filler pipe 14 for introducing fuel into the fuel tank 12. The vehicle fuel system may further include an evaporative emissions system 16 (e.g., carbon canister) to which fuel vapor is vented from the tank 12 through valve 10 via a vent line 18. Venting valve 10 may be configured so that vapor may rise through the venting valve 10. The venting valve 10 may be generally mounted in a vent hole in a fuel tank 12 of a vehicle fuel system. Although various elements of a vehicle fuel system are generally described and illustrated, the venting valve 10 in accordance with the present disclosure may be utilized in any number of vehicle fuel systems which omit certain elements that are described or illustrated and/or include additional elements that are not described or illustrated herein. The venting valve 10 may be configured for use between a vehicle fuel tank vent and the vapor recovery system 16. Components referred to herein as lines may also be referred to as conduits, and components referred to herein as conduits may also be referred to as lines.

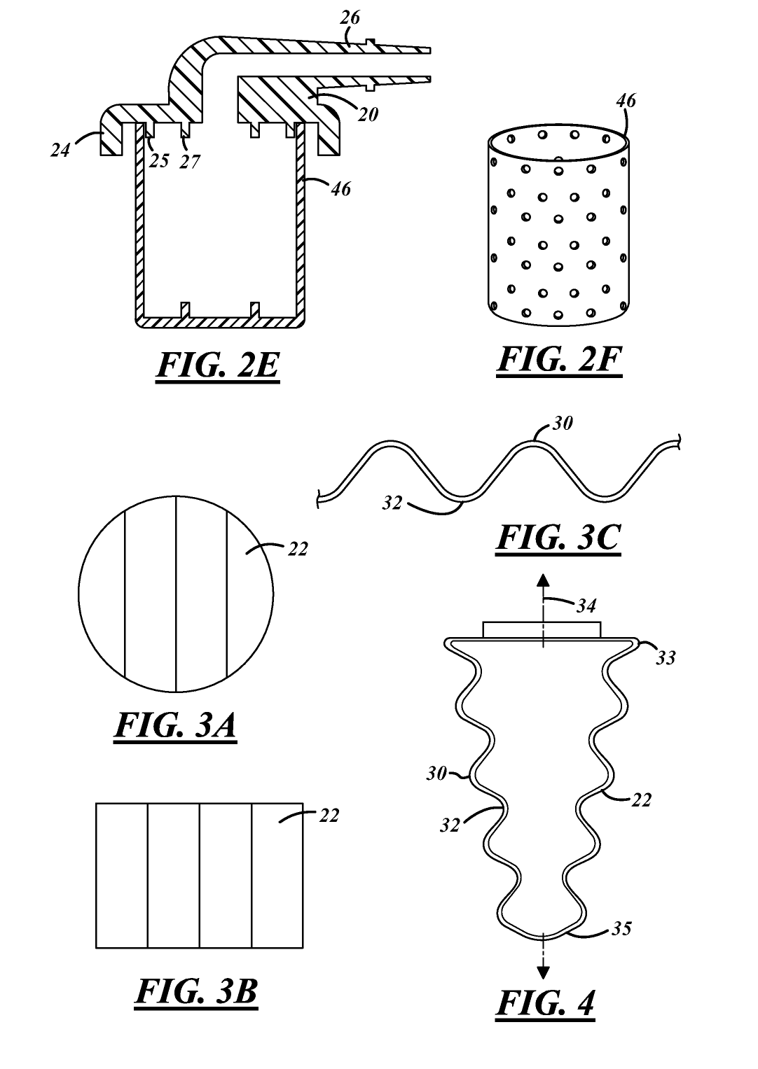

Referring now to FIG. 2A, the venting valve 10 may comprise a cover 20 (e.g., cap) and a liquid discriminating and vapor permeable membrane 22, also referred to herein as a membrane filter. The cover 20 may be molded, for example, from a fuel resistant plastic and may be mounted in a wall of the fuel tank 12. The cover 20 may be mounted to the fuel tank 12 using any known and/or conventional method and/or manner, including for example, welding (e.g., ultrasonic welding), bonding (e.g., with adhesive), a camlock design with an elastomeric seal, and/or fasteners (e.g., screws, bolts, rivets, brads, etc.). The cover 20 may include a flange 24 configured to support the venting valve 10 in a fuel tank 12 of a vehicle fuel system. For example, the flange 24 may be generally circular in shape in accordance with an embodiment of the disclosure. The cover 20 may further include a flow path 26 (e.g., a port, a line, or any other path). Flow path 26 may be configured for fluidly connecting a venting orifice (to which vapor may rise through the venting valve 10) to the evaporative emissions system 16 (e.g., carbon canister). Accordingly, flow path 26 of cover 20 may be in fluid communication with the evaporative emissions system 16 and may allow for the transfer of vapor from fuel tank 12 to the evaporative emissions system 16.

In accordance with an embodiment of the disclosure, the membrane 22 of venting valve 10 may be connected to cover 20. For example and without limitation, the venting valve 10 may include a means 28 for connecting the membrane 22 to the cover 20. Means 28 may also be configured to ensure that the flow path of fluid from the fuel tank 12 is through membrane 22 (i.e., membrane 22 cannot be bypassed). Referring now to FIG. 2B, in accordance with an embodiment of the disclosure, the membrane 22 of venting valve 10 may be directly connected to cover 20. For example, in an embodiment, the means 28 for connecting the membrane 22 to the cover 20 may include one or more projections 25, 27 defining a channel into which the membrane 22 may be disposed. The membrane 22 may be connected to the cover 20 using adhesive located in the channel defined by the projections 25, 27, insert molding, or otherwise embedding the membrane. The membrane 22 may further utilize an end cap 36 as described further herein in accordance with an embodiment of the disclosure. In accordance with another embodiment, means 28 may comprise a post 29 that is substantially centered relative to cover 20 of venting valve 10 in an embodiment of the disclosure, as generally illustrated in FIG. 7, for example. The post 29 may comprise plastic in an embodiment of the disclosure. The post 29 may be connected to the cover 20 using any known and/or conventional method and/or manner, including, for example and without limitation, an insert molding process, welding (e.g., ultrasonic welding), heat sealing, bonding (e.g., with adhesives), a combination thereof, or any number of other processes. The post 29 may also be connected to the membrane 22. The post 29 may be connected to the membrane 22 using any known and/or conventional method and/or manner, including for example and without limitation, an insert molding process, welding (e.g., ultrasonic welding), heat sealing, bonding (e.g., with adhesives), a combination thereof, or any number of other processes. Although means 28 are described in detail as projections 25, 27 and/or post 29 in accordance with various embodiments of the disclosure, means 28 may comprise any element and/or member and/or process that is configured to connect the membrane 22 to cover 20 and to ensure that the flow path for fluid from the fuel tank 12 is through the membrane 22 (i.e., that fluid cannot bypass membrane 22).

The membrane 22 may be configured to allow passage of air and/or fuel vapor while blocking passage of liquid fuel. The membrane 22 may be a liquid discriminating membrane. In accordance with an embodiment of the disclosure, the membrane 22 may be configured so that it does not change the hydrocarbon concentration of the air and/or fuel vapor that passes through the membrane 22. Fuel vapor may enter the venting valve 10 at the fuel tank side of the venting valve. To increase the surface area of the membrane 22 while maintaining substantially the same dimensions and physical space requirements as conventional membrane packaging for venting valves (e.g., substantially disk shaped membranes), the membrane 22 may comprise a number of various packages or methods for packaging as described herein.

Referring to FIGS. 2A, 2C, and 2D, in accordance with embodiments of the disclosure, the membrane 22 may comprise a rippled, corrugated, and/or wavy membrane package. In particular, at least a portion of the outer surface of the membrane 22 may comprise a plurality of alternating curved crests 30 and valleys 32 that define ripples, corrugations, and/or waves on the outer surface of the membrane 22. In other words, at least a portion of the outer surface of the membrane 22 has a substantially sinusoidal profile. The membrane 22 may be formed into a substantially columnar shape, having a longitudinal axis 34, in accordance with an embodiment of the disclosure and as generally illustrated in FIG. 2A. The longitudinal axis 34 of the substantially columnar membrane 22 may extend perpendicularly from cover 20. The ripples, corrugations, and/or waves defined by the curved crests 30 and valleys 32 may also extend along the longitudinal axis 34 of the substantially columnar membrane 22. The membrane 22 may form a hollow member in accordance with an embodiment of the disclosure. Although the membrane 22 is described as being a substantially columnar hollow member, the membrane 22 may comprise any number of other shapes in other embodiments.

For example, referring now to FIGS. 3A-3B which show top views of a membrane 22 for use with a venting valve 10 in accordance with another embodiment of the disclosure, the membrane 22 may be not curved into a substantially cylindrical hollow member. Instead, the membrane 22 may be relatively flat. As generally illustrated in FIG. 3A, the membrane 22 may be substantially circular in shape and/or disk-shaped. As generally illustrated in FIG. 3B, the membrane 22 may be substantially rectangular in shape. Although these two shapes are described and illustrated, the membrane 22 may comprise any number of shapes, including, for example, irregular shapes, in other embodiments of the disclosure. As best seen in the side view illustrated in FIG. 3C, the membrane 22 continues to comprise a plurality of alternating curved crests 30 and valleys 32 that define ripples, corrugations, and/or waves on the outer surface of the membrane 22. Accordingly, the membrane 22 is not actually flat, but has a substantially sinusoidal profile and continues to have an increased surface area because of the ripples, corrugations, and/or waves formed on the outer surface. The membrane 22 may be connected to venting valve 10 using means 28 (e.g., projections and/or a post configured to connect membrane 22 to cover 20 and/or any known and/or conventional method and/or manner, including for example, an insert molding process, welding (e.g., ultrasonic welding), heat sealing, bonding (e.g., with adhesives), a combination thereof, or any number of other processes). In accordance with an embodiment of the disclosure, the means 28 may comprise a direct connection between membrane 22 and cover 20 in accordance with an embodiment of the disclosure such that no separate connecting element (such as projections or a post) is necessary.

For another example of a rippled, corrugated, and/or wavy membrane package that does not include a substantially columnar hollow member, reference is now made to FIG. 4. The membrane 22 may be formed into a substantially wedge-shaped and/or V-shaped package. A first end 33 of the membrane 22 may be wider than a second opposing end 35 of the membrane 22. However, at least a portion of the outer surface of the membrane 22 may continue to comprise a plurality of alternating curved crests 30 and valleys 32 that define ripples, corrugations, and/or waves on the outer surface of the membrane 22. Accordingly, at least a portion of the outer surface of the membrane 22 may have a substantially sinusoidal profile. The ripples, corrugations, and/or waves may extend perpendicularly to the longitudinal axis 34 of the substantially wedge-shaped and/or V-shaped membrane 22. The membrane 22 may be connected to venting valve 10 using means 28 described herein and/or any known and/or conventional method and/or manner, including for example, an insert molding process, welding (e.g., ultrasonic welding), heat sealing, bonding (e.g., with adhesives), a combination thereof, or any number of other processes.). In accordance with an embodiment of the disclosure, the means 28 may comprise a direct connection between membrane 22 and cover 20 in accordance with an embodiment of the disclosure such that no separate connecting element (such as projections or a post) is necessary. One or more substantially triangular shaped pieces (not shown) may be used to seal the edges of the membrane 22 in order to maintain a closed inner vapor space separate from the fuel tank vapor space.

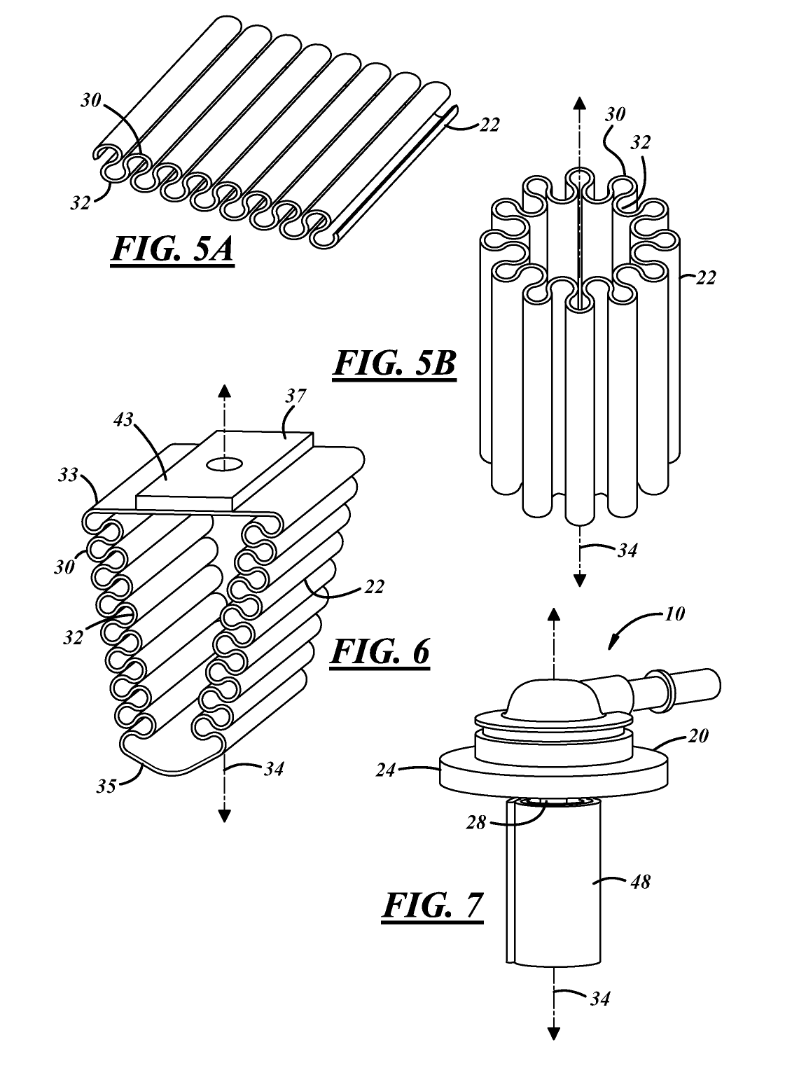

In accordance with another embodiment of the disclosure, the membrane 22 may comprise a ribbon-like membrane package. Referring now to FIGS. 2D and 5A-5B, at least a portion of the outer surface of the membrane 22 may continue to comprise a plurality of alternating curved crests 30 and valleys 32. However, as opposed to creating relatively shallow ripples, corrugations, and/or waves on the outer surface of the membrane, at least one of the plurality of curved crests 30 may have a profile that is at least substantially hemispherical. Also, in some embodiments, at least one of the plurality of curved valleys 32 may have a profile that is at least substantially hemispherical. In some embodiments, each of the plurality of curved crests 30 and/or valleys 32 may have a profile that is at least substantially hemispherical. In accordance with an embodiment of the disclosure, at least one of the plurality of curved crests 30 and/or at least one of the plurality of curved valleys 32 may have a profile that extends about equal to or greater than about 180° of a circle. In some embodiments, each of the plurality of curved crests 30 and/or valleys 32 may have a profile that extends about equal to or greater than about 180° of a circle. In accordance with an embodiment of the disclosure, at least one of the plurality of curved crests 30 may have a profile that extends at least about 270° of a circle. In some embodiments, at least one of the plurality of curved valleys 32 may have a profile that extends at least about 270° of a circle. In some embodiments, each of the plurality of curved crests 30 and/or valleys 32 may have a profile that extends about equal to or greater than about 270° of a circle. Accordingly, the ripples, corrugations, and/or waves on the outer surface may be more pronounced than those generally illustrated in FIGS. 3A-3C. In other words, at least a portion of the outer surface of the membrane 22 may have a substantially corrugated profile.

The membrane 22 may also be formed in to a substantially columnar shape, having a longitudinal axis 34, in accordance with an embodiment of the disclosure and as generally illustrated in FIG. 5B. The longitudinal axis 34 of the substantially columnar membrane 22 may extend perpendicularly from cover 20. The membrane 22 may be connected to venting valve 10 using means 28 (e.g., projections and/or a post and/or any known and/or conventional method and/or manner, including for example, an insert molding process, welding (e.g., ultrasonic welding), heat sealing, bonding (e.g., with adhesives), a combination thereof, and/or a direct connection between membrane 22 and cover 20, or any number of other processes and/or embodiments). The pronounced ripples and/or waves may extend along the longitudinal axis 34 of the substantially columnar membrane 22. The membrane 22 may form a hollow member in accordance with an embodiment of the disclosure. Although the membrane 22 is described as being a substantially cylindrical columnar member, the membrane 22 may comprise any number of other shapes in other embodiments.

For example, as generally illustrated in FIG. 6, the membrane 22 may be formed into a substantially wedge-shaped and/or V-shaped package. A first end 33 of the membrane 22 may be wider than a second opposing end 35 of the membrane 22. However, at least a portion of the outer surface of the membrane 22 continues to comprise a plurality of alternating curved crests 30 and valleys 32 that define a rippled profile as generally shown in FIG. 5A on the outer surface of the membrane 22. Accordingly, in other words, at least a portion of the outer surface of the membrane 22 has a substantially corrugated profile. The ripples may extend perpendicularly to the longitudinal axis 34 of the substantially wedge-shaped and/or V-shaped membrane 22. The membrane 22 may be connected to venting valve 10 using means 28 (e.g., projections and/or a post and/or any known and/or conventional method and/or manner, including for example, an insert molding process, welding (e.g., ultrasonic welding), heat sealing, bonding (e.g., with adhesives), a combination thereof, and/or a direct connection between membrane 22 and cover 20, or any number of other processes and/or embodiments). As generally illustrated in FIG. 6, means 28 may comprise plate 37 that is generally shown at the first wider end 33 of the membrane 22. Plate 37 may be configured for connection to membrane 22 using an insert molding process, welding (e.g., ultrasonic welding), heat sealing, bonding (e.g., with adhesives), or a combination thereof. Plate 37 may be considered an end cap in accordance with some embodiments of the disclosure. One or more substantially triangular shaped pieces (not shown) may be used to seal the edges of the membrane 22 in order to maintain a closed inner vapor space separated from the fuel tank vapor space.

Referring back to FIG. 2B, in accordance with various embodiments of the disclosure, the venting valve 10 may further comprise a first end cap 36. First end cap 36 may be connected to a first end 38 of the hollow member formed by membrane 22. First end cap 36 may be configured for sealing the first end 38 of the hollow member and/or retaining the shape of the hollow member. First end cap 36 may be connected to membrane 22 using any known and/or conventional method and/or manner in the art, including for example, adhesives. First end cap 36 may include a plurality of projections 40, 42 defining a channel into which the membrane 22 may be disposed. FIG. 2B generally shows first end cap 36 connected to membrane 22 using adhesive. Venting valve 10 may further comprise a second end cap (not shown) in accordance with some embodiments of the disclosure. The second end cap may be connected to a second end of the hollow member formed by membrane 22 that opposes the first end 38. The second end cap may be used in addition to and/or as part of means 28 for connecting the membrane 22 to the cover 20. The second end cap, if any, may also be connected to membrane 22 using any known and/or conventional method and/or manner in the art, including for example, adhesives. The second end cap may include a hole for vapor flow. The hole may be in fluid communication with the flow path 26 of cover 20. Vapor may flow from fuel tank 12, through membrane 22, through the hole of the second end cap and/or through cover 20, through the flow path 26, and to evaporative emissions system 16. In this way, the membrane 22 provides two distinct vapor spaces (i.e., the first vapor space is inside the fuel tank 12 and the second vapor space is outside the fuel tank 12). Although first end caps 36 and second end caps are described in detail, end caps may not necessarily be used in connection with the embodiments of the disclosure. For example and without limitation, first end cap 36 may not be used in connection with wedge-shaped and/or V-shaped membranes generally illustrated in FIGS. 4 and 6. For another example, holes for vapor flow may be placed directly in the membrane itself.

Referring now to FIG. 2A, in accordance with an embodiment of the disclosure, the venting valve 10 may further comprise a structural support member 44 extending through the hollow member defined by the membrane 22. The structural support member 44 may be configured to be disposed in the hollow member. In one embodiment, the support member 44 may comprise a solid support. In other embodiments, the support member 44 may comprise a mesh structure support. The support member 44 may be generally cylindrical or columnar in an embodiment. Although the support member 44 is described as being generally cylindrical or columnar, the support member 44 may, however, comprise any number of other shapes in other embodiments. The support member 44 may extend along the longitudinal axis 34 of membrane 22. The support member 44 may be configured for press-fit insertion through the hollow member defined by the membrane 22. The support member 44 may function as a gap spacer in some embodiments of the disclosure, and may be configured to maintain the gap between opposing sides of the membrane 22. For example, a support member may be configured to support the wedge-shaped and/or V-shaped membrane 22 generally shown in FIGS. 4 and 6, and to maintain a gap between opposing sides of the membrane 22. The support member 44 may also comprise means 28 for connecting the membrane 22 to the cover 20 in accordance with an embodiment of the disclosure.

In some embodiments, the venting valve 10 may further comprise a housing 46 that at least partially surrounds (e.g., is exterior to) the membrane 22 as generally illustrated in FIGS. 2E-2F. The housing 46 may be cylindrical or generally cylindrical in shape in accordance with an embodiment of the disclosure. The housing 46 may be configured to prevent liquid fuel from splashing onto the membrane 22, which could potentially affect the functionality of the membrane 22. The housing 46 may also be configured to prevent external damage (e.g., crushing) of the membrane 22. Although the housing 46 is generally illustrated as surrounding the membrane 22, the housing 46 does not have to surround and/or be exterior to the membrane 22. In accordance with various embodiments of the disclosure, the housing 46 may be interior to the membrane 22. Such an embodiment with an interior housing 46 may still be configured to prevent external damage (e.g., crushing) of the membrane 22, but would not necessarily be configured for splash protection. In accordance with some embodiments of the disclosure, the housing 46 may be perforated (as generally illustrated in FIG. 2F), may include slits, may comprise mesh, and/or any other similar variation configured to permit venting of the housing 46. Although a housing 46 is described in connection with venting valve 10, the housing 46 is not necessary and may not be utilized in accordance with some embodiments of the disclosure.

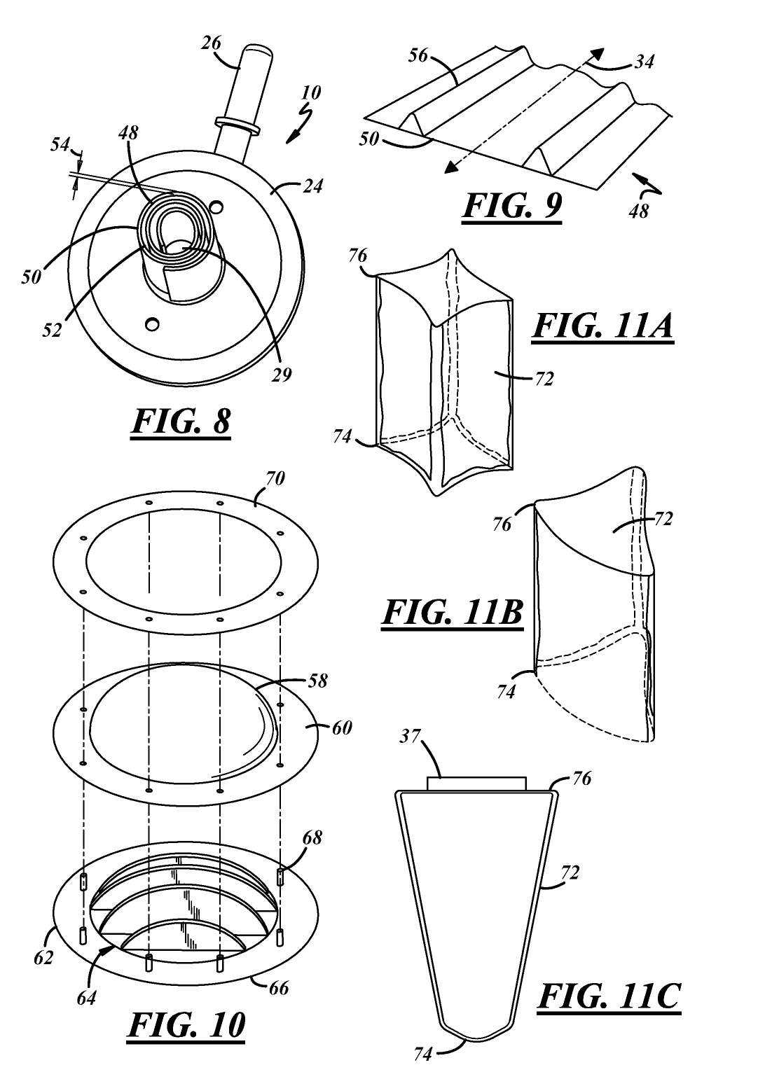

In accordance with another embodiment of the disclosure, the venting valve 10 may include a spiral-wound membrane package as generally illustrated in FIGS. 7-8. Elements of the venting valve 10 (including for example, but not limited to, cover 20, flange 24, flow path 26, means 28, housing 46) may be identical and/or substantially similar to the elements described in connection with other embodiments of the disclosure, except the membrane may comprise a spiral-wound membrane 48. Spiral-wound membrane 48 may be liquid discriminating and vapor permeable. Spiral-wound membrane 48 may be configured to allow for the passage of air and/or fuel vapor, while blocking the passage of liquid fuel. In accordance with an embodiment of the disclosure, the spiral-wound membrane 48 may be configured so that it does not change the hydrocarbon concentration of the air and/or fuel vapor that passes through the spiral-wound membrane 48. The spiral wound membrane 48 may be connected to venting valve 10 using means 28 described herein (e.g., post 29 and/or any known and/or conventional method and/or manner, including for example, an insert molding process, welding (e.g., ultrasonic welding), heat sealing, bonding (e.g., with adhesives), a combination thereof, or any number of other processes). In accordance with an embodiment of the disclosure, the means 28 may comprise a direct connection between membrane 22 and cover 20 in accordance with an embodiment of the disclosure such that no separate connecting element (such as projections or a post) is necessary.

The spiral-wound membrane 48 may comprise a substantially flat membrane that is first folded (e.g., folded in half) to make an envelope. The edges of the membrane 48 may be sealed in order to create a first vapor space inside the envelope and a second vapor space outside the envelope (e.g., the fuel tank vapor space). Accordingly, the membrane 48 may comprise a first and second layer 50, 52 (e.g., the first half of the substantially flat membrane is the first layer 50, and the second half of the substantially membrane is the second layer 52). The membrane 48 comprising the folded envelope may then be spirally wound (e.g., rolled up into a spiral-wound membrane 48).

The first and second layers 50, 52 of the membrane 48 may define a gap 54 therebetween. In one embodiment, the membrane 48 may be generally self-supporting to retain gap 54 between layers 50, 52. In other embodiments, the membrane 48 may use a device 56 that is configured to maintain the gap 54 between the first and second layer 50, 52 of the membrane 48. For example, the device 56 may comprise a runner.

Referring now to FIG. 9, device 56 is generally illustrated as a plurality of runners. The runners 56 may extend along the longitudinal axis 34 of the spiral-wound membrane 48 in an embodiment of the disclosure. In other embodiments, the runners 56 may extend perpendicularly to and/or at any other angle relative to the longitudinal axis 34 of the spiral-wound membrane 48. The runners 56 may extend the entire length of the first layer 50 and/or second layer 52 of the spiral-wound membrane 48 or may extend only along a portion of the first layer 50 and/or second layer 52 of the spiral-wound membrane 48. The runners 56 may generally comprise a flexible material and may comprise a plastic in an embodiment of the disclosure. The runners 56 may have a substantially triangular cross-section in an embodiment of the disclosure, although the runners may comprise any number of shapes in accordance with other embodiments of the disclosure. Each of the runners 56 may be attached to the membrane 48 through a process, such as insert molding, ultrasonic welding, etc. or be inserted as a separate piece between the layers 50, 52 of the membrane 48. The device 56 is not limited to runners as illustrated and may include any other device configured to create and/or maintain the gap 54 between the first and second layers 50, 52 of the spiral-wound membrane 48. For example and without limitation, in other embodiments, the device 56 may comprise a mesh, screen, net, braid, etc. The device 56 comprising a mesh, screen, net, braid, etc. may also comprise a flexible material and/or may also comprise plastic in accordance with embodiments of the disclosure.

The membrane 48 may also include a hole (not shown) for vapor flow. The hole may be in fluid communication with the flow path 26 of the cover 20. Vapor may flow from fuel tank 12, through layer 50 or layer 52 of membrane 48, through the gap 54 defined between layers 50 and 52 of membrane 48, through the hole of the membrane 48, through the flow path 26, and to the vapor recovery system 16. In this way, the membrane 48 provides two distinct vapor spaces (i.e., the first vapor space is inside the fuel tank 12, and the second vapor space is outside the fuel tank 12). The membrane envelope makes up part of the second vapor space outside the fuel tank 12.

In accordance with another embodiment of the disclosure, the venting valve 10 may include a dome membrane package as generally illustrated in FIG. 10. Elements of the venting valve 10 (including for example, but not limited to, cover 20, flange 24, flow path 26, post 28, housing 46) may be identical and/or substantially similar to the elements described in connection with other embodiments of the disclosure, except the membrane may comprise a dome membrane 58. Dome membrane 58 may also be liquid discriminating and vapor permeable. Dome membrane 58 may also be configured to allow for the passage of air and/or fuel vapor, while blocking the passage of liquid fuel. Membrane 58 may not generally be configured to filter the fuel vapor (i.e., substantially change (e.g., lower and/or increase) the hydrocarbon concentration of the fuel vapor) in an embodiment of the disclosure. At least a portion of dome membrane 58 may be generally curved and/or hemispherical in an embodiment of the disclosure. The dome membrane 58 may further include a circumferentially extending flange 60 that may be used to connect the dome membrane 58 to the venting valve 10.

In order to provide support and/or form the dome membrane 58 of the membrane package, a corresponding protrusion 62 may be provided. Protrusion 62 may comprise a rib member in accordance with an embodiment of the disclosure. For example and without limitation, protrusion 62 may comprise at least one curved rib 64 that is configured to support and/or shape the membrane 58. The dome membrane 58 may be configured to be provided and/or placed on the protrusion 62 (e.g., on a rib 64 of the protrusion 62 in an embodiment of the disclosure). Protrusion 62 may further comprise a circumferentially extending flange 66 in accordance with an embodiment of the disclosure. Flange 66 may include at least one lug and/or tooth 68. Lugs and/or teeth 68 may be used to hold the membrane 58 in place. In particular, lugs and/or teeth 68 may be used to hold flange 60 of membrane 58 in place against flange 66 of protrusion 62. A corresponding ring 70 that matches up with flanges 60 and 66 may also be used to retain membrane 58 in place. The dome membrane 58 may be connected to venting valve 10 so that the curved and/or hemispherical portion (i.e., the convex side) faces cover 20 of venting valve 10 in an embodiment. The dome membrane 58 may also be connected to venting valve 10 so that the curved and/or hemispherical portion (i.e., the convex side) faces away from cover 20 of venting valve 10 (i.e., toward fuel tank 12). The dome membrane 58 may be connected to venting valve 10 using post 29 described herein and/or any known and/or conventional method and/or manner, including for example, an insert molding process, welding (e.g., ultrasonic welding), heat sealing, bonding (e.g., with adhesives), a combination thereof, or any number of other processes. The dome membrane 58 may also be directly connected to cover 20 in accordance with an embodiment of the disclosure.

A first side of the dome membrane 58 (e.g., the convex side or concave side) may be in fluid communication with the vapor space inside the fuel tank 12. A second, opposing side of the dome membrane (e.g., the concave side or convex side, respectively) may be in fluid communication with the vapor space including flow path 26 of cover 20. Vapor may flow from fuel tank 12, through membrane 58, through the flow path 26, and to evaporative emissions system 16. In this way, the dome membrane 58 provides two distinct vapor spaces (i.e., the first vapor space is inside the fuel tank 12 and the second vapor space is outside the fuel tank 12).

Although these various embodiments have been described in detail, there may be numerous other variations for methods of packaging a membrane for use in a venting valve that may increase the surface area in order to improve the functionality of the membrane, while not requiring significant increases in physical space requirements for the venting valve. For example and without limitation, in other embodiments, the membrane may comprise a sock-type membrane package as generally illustrated in FIGS. 11A-11B. In the sock-type membrane package, the membrane 72 may comprise a hollow member formed by one or a plurality of panels. The membrane 72 may comprise four side panels as generally illustrated in FIG. 11A, and accordingly may comprise a rectangular shape. However, in other embodiments, the membrane 72 may comprise fewer or more panels (e.g., three side panels forming a triangular shape as generally illustrated in FIG. 11B). Although four side panels and three side panels are mentioned and generally illustrated, the membrane 72 may comprise any number and types of panels in various embodiments. For example, as generally illustrated in FIG. 11C, the membrane 72 may comprise a single panel formed into a V-shaped and/or wedge-shaped membrane package. A first end 76 of the membrane 72 may be wider than a second opposing end 74 of the membrane 72. One or more substantially triangular shaped pieces (not shown) may be used to seal the edges of the V-shaped and/or wedge shaped membrane package generally illustrated in FIG. 11 C to maintain a closed inner vapor space separate from the fuel tank vapor space.

The membrane 72 may be sealed at a second end 74. As shown in FIGS. 11A-11B, a bottom panel may seal the multiple side panels of the hollow member through the use of seams.

As shown in FIG. 11C, the single panel of the V-shaped itself creates a sealed second end 74. The membrane 72 may include a plate 37 and/or an end cap (not shown) at a first end 76, the first end 76 opposing the second end 74. The end cap may be configured for retaining the shape of the hollow member in some embodiments of the disclosure. The end cap may be connected to the membrane 72 using any known and/or conventional method and/or manner in the art, including for example, adhesives. The end cap may include a hole for vapor flow. The hole in the end cap may be in fluid communication with the flow path 26 of cover 20. Vapor may thus flow from fuel tank 12, through membrane 72, through the hole of the end cap, through flow path 26, and to evaporative emissions system 16. In this way, the membrane 72 provides two distinct vapor spaces (i.e., the first vapor space is inside the fuel tank 12 and the second vapor space is outside the fuel tank 12). Although an end cap is described in detail, an end cap may not necessarily be used in connection with the embodiments of the disclosure. For example, the membrane 72 itself and/or plate 37 may include a hole for vapor flow, without the use of an end cap. The membrane 72 may be connected to venting valve 10 using means 28 described herein and/or any known and/or conventional method and/or manner, including for example, an insert molding process, welding (e.g., ultrasonic welding), heat sealing, bonding (e.g., with adhesives), a combination thereof, or any number of other processes.

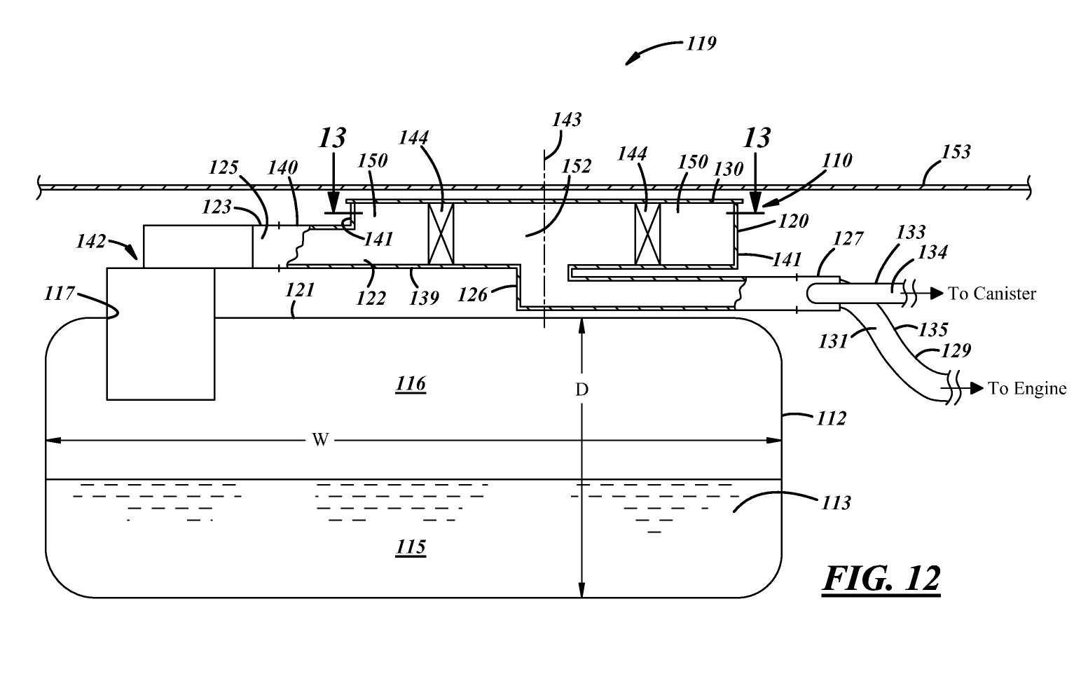

With reference now to FIG. 12, a portion of a system 119 is shown. The system 119 can be a vehicle fuel system, or can be another liquid containment and vapor venting system, such as for a urea tank. In the embodiment shown, the system 119 is described as a vehicle fuel system that includes a fuel tank 112. It should be appreciated, however, that the tank 112 could be a urea tank or a tank for containing another liquid. The system 119 has an externally mounted venting valve, that may be referred to as a liquid vapor discriminator valve, or alternatively can be referred to as an in-line liquid vapor discriminator trap constructed in accordance to one example of the present disclosure and is shown and generally identified at reference 110. The in-line liquid vapor discriminator trap 110 is configured to trap and return liquid fuel to the fuel tank 112. The in-line liquid vapor discriminator trap 110 can momentarily trap liquid fuel and subsequently allow the liquid fuel to drain back into the fuel tank 112, thereby keeping vapor vent lines and other components downstream of the liquid vapor discriminator trap 110 free of liquid fuel.

The fuel tank 112 defines an interior space 113 that holds liquid fuel 115 and fuel vapor in a vapor space 116 above the liquid fuel 115. The fuel tank 112 has a depth D and a width W. The depth D extends generally along a vertical axis and the width W extends generally along a horizontal axis when the fuel tank 112 is in the upright position shown in FIG. 12, such as when a vehicle on which the system 119 is installed is on a level grade. A venting valve 142 can be mounted in an opening 117 in an upper wall 121 of the fuel tank 112. The venting valve 142 can be a shutoff valve, a rollover valve, can include sensors that indicate pressure in the tank 112, or can perform all of these functions as well as other known functions. A first line 123, also referred to herein as a first vapor vent conduit or as a first vapor vent line or first passage, extends from the venting valve 142 and defines a first passage 125 that is in fluid communication with the interior space 113 when the venting valve 142 opens the passage 125 to the tank 112, such as to permit vapor passage from the fuel tank 112. Alternatively, the first line 123 could connect directly to the tank 112 in an embodiment without a venting valve 142.

The in-line liquid vapor discriminator trap 110 can generally include a housing 120 that defines an inlet 140, also referred to as an inlet port, and an outlet 126, also referred to as an outlet port. The outlet 26 extends generally parallel with the wall 121 of the fuel tank 112. A T-connector 127 connects the outlet 126, either directly or via an intermediate line, to a second conduit 129, also referred to herein as a second vapor vent conduit, or as a second vapor vent line. The second conduit 129 has an internal passage 131 that is operatively connected to the vehicle engine (not shown). The line 129 descends relative to the first line 123 and the fuel tank 112, as shown at descending portion 135, when the tank 112 is positioned generally upright so that the upper wall 121 is generally level. In other words, the descending portion 135 is closer to the fuel level within the tank 112 than the first passage 123 is to the fuel level. Stated differently, the descending portion 135 extends generally away from the in-line liquid vapor discriminator trap 110 and further in the direction of the depth D of the fuel tank 112 than does the line 133. The T-connector 127 also operatively connects the line 129 to a conduit 133, also referred to herein as a vapor vent line, with an internal passage 134 that is in fluid communication with an evaporative canister (not shown). Accordingly, a vacuum in the line 129 can cause purging of the canister through line 133, drawing vapors to the engine.

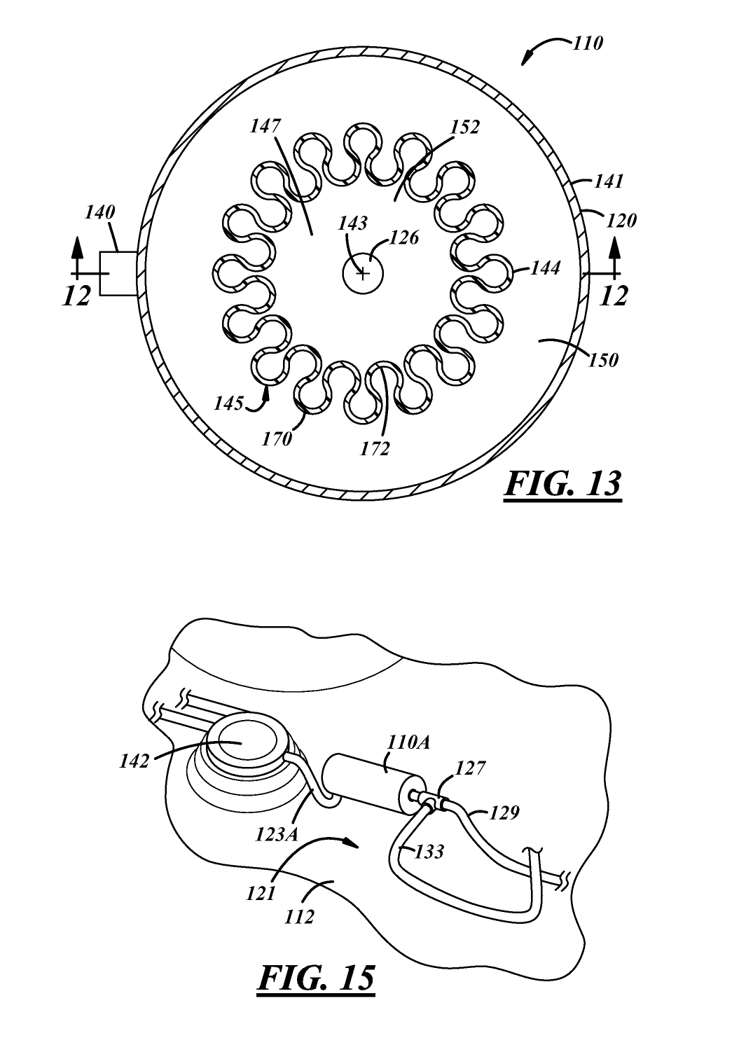

A top cap 130 can be coupled to the housing 120 such as by welding. As shown in a schematic top view in FIG. 13 of the in-line liquid vapor discriminator trap 110 with the top cap 130 removed, the housing 120 includes a generally cylindrical wall 141. The inlet 140 extends through the generally cylindrical wall. The top cap 130 can be referred to as a first end or end wall. The housing 120 also has a second end or end wall 139. The outlet 126 extends through the end wall 139.

A membrane filter 144 is positioned in the housing 120. The membrane filter 144 can inhibit liquid fluid from passing from the first line 123 and the inlet 140 to the outlet 126 and the lines 129 and 133 downstream in vapor flow from the filter 144. The filter 144 can be an oleophobic filter membrane that can prevent liquid from passing through the in-line liquid vapor discriminator trap 110 from the inlet 140 to the outlet 126. The membrane filter 144 is also referred to herein as a membrane.

In the embodiment shown, the membrane filter 144 is generally columnar and has a center axis 143 that is the same as the center axis of the generally cylindrical wall 141. As indicated by the center axis 143, the filter 144 is positioned generally upright, so that the center axis 143 is generally perpendicular to the upper wall 121 of the tank 112. The end wall 139 could be seated directly on the upper wall 122 with the outlet 126 fitting in a recess or valley, or over an edge of the upper wall 121. The entire liquid vapor discriminator trap 110 fits in the relatively small packaging space between a floor pan 153 of the vehicle and the upper wall 121 of the tank 112. The liquid vapor discriminator trap 110 has no moving components. As such, the liquid vapor discriminator trap 110 is more amenable to a tight packaging space than, for example, a valve that requires a float, as there is very little vertical distance between the upper wall 121 of the tank 112 and the floor pan 153 to accommodate a moving float, and likely, a biasing spring for the float.

As shown in FIG. 13, the filter 144 is nonplanar, and has a plurality of peaks 170 and valleys 172 that increase the area of an external surface 145 of the filter 144 relative to a true cylindrical surface. In other embodiments, the filter 144 can be folded, pleated, can be a true cylindrical shape, a wedge shape, or any other shape configured to separate the inlet 140 from the outlet 126 when the filter 144 is positioned in the housing 120. In one example, the filter 144 can be sealed to the top cap 130 and to the end wall 139.

The filter 144 divides an internal housing cavity 147 into a generally annular outer vapor space 150, and a generally cylindrical inner vapor space 152. The outer vapor space 150 can be referred to as an overflow ring, as the filter 144 will stop any liquid fuel that flows through the inlet 140. The inlet 140 is positioned relatively low in the housing 120 to encourage the liquid to drain back to the fuel tank 112 through the line 123 and valve 142.

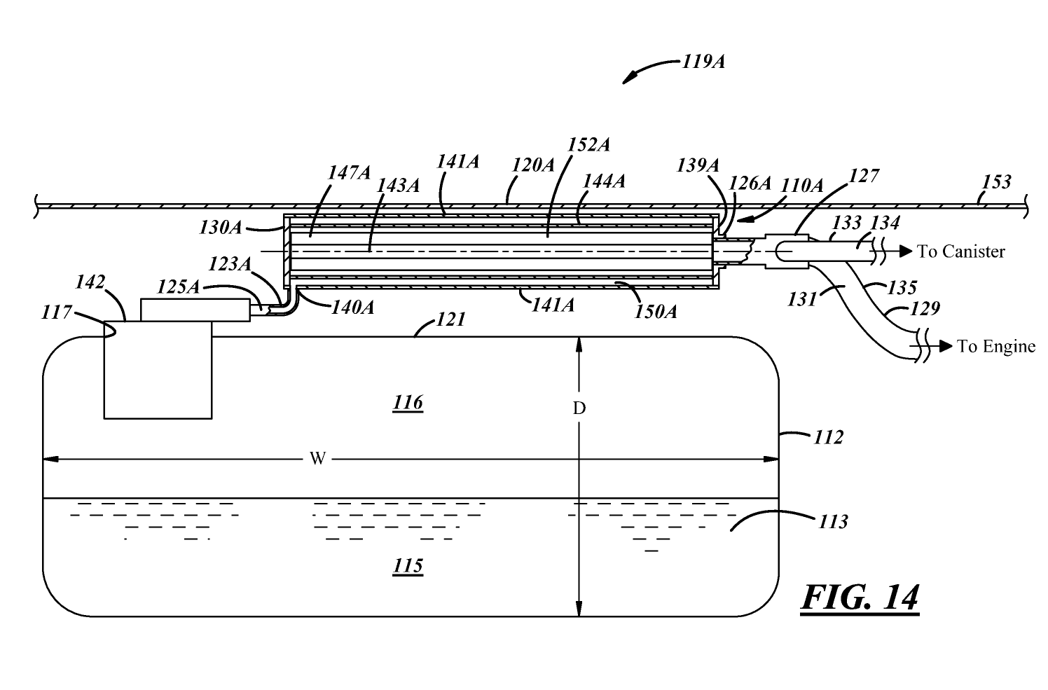

With reference now to FIG. 14, a portion of a system 119A is shown. The system 119A is alike in many aspects to system 119. Components that are substantially identical to those of system 119 are indicated with identical reference numbers. The system 119A can be a vehicle fuel system, or can be another liquid containment and vapor venting system, such as for a urea tank. In the embodiment shown, the system 119A is described as a vehicle fuel system that includes a fuel tank 112. It should be appreciated, however, that the tank 112 could be a urea tank or a tank for containing another liquid. The system 119A has an externally mounted venting valve, that may be referred to as a liquid vapor discriminator valve, or alternatively can be referred to as an in-line liquid vapor discriminator trap constructed in accordance to one example of the present disclosure and is shown and generally identified at reference 110A. The in-line liquid vapor discriminator trap 110A is configured to trap and return liquid fuel to the fuel tank 112. The in-line liquid vapor discriminator trap 110A can momentarily trap liquid fuel and subsequently allow the liquid fuel to drain back into the fuel tank 112, thereby keeping vapor vent lines and other components downstream of the liquid vapor discriminator trap 110A free of liquid fuel.

The fuel tank 112 defines an interior space 113 that holds liquid fuel 115 and fuel vapor in a vapor space 116 above the liquid fuel 115. The fuel tank 112 has a depth D and a width W. The depth D extends generally along a vertical axis and the width W extends generally along a horizontal axis when the fuel tank 112 is in the upright position shown in FIG. 14, such as when a vehicle on which the system 119 is installed is on a level grade. A venting valve 142 can be mounted in an opening 117 in an upper wall 121 of the fuel tank 112. The venting valve 142 can be a shutoff valve, a rollover valve, can include sensors that indicate pressure in the tank 112, or can perform all of these functions as well as other known functions. A first line 123A, also referred to herein as a first vapor vent conduit or as a first vapor vent line, extends from the venting valve 142 and defines a first passage 125A that is in fluid communication with the interior space 113 when the venting valve 142 opens passage 125A to the tank 112, such as to permit vapor passage from the fuel tank 112. Alternatively, the first line 123A could connect directly to the tank 112 in an embodiment without a venting valve 142.

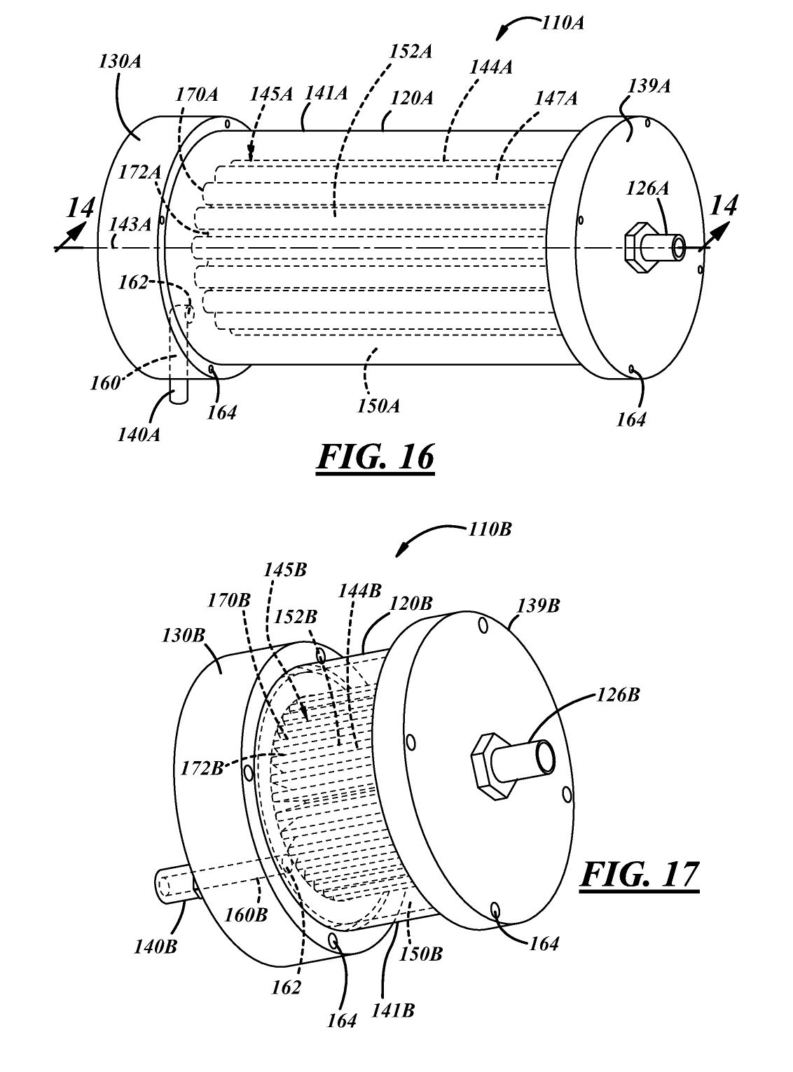

The in-line liquid vapor discriminator trap 110A is also shown in FIG. 16, and can generally include a housing 120A that defines an inlet 140A, also referred to as an inlet port, and an outlet 126A, also referred to as an outlet port. A T-connector 127 connects the outlet 126A, either directly or via an intermediate line, to a second conduit 129, also referred to herein as a second vapor vent conduit or as a second vapor vent line. The second conduit 129 has an internal passage 131 that is operatively connected to the vehicle engine (not shown). The line 129 descends relative to the first line 123A and the fuel tank 112, as shown at descending portion 135, when the tank 112 is positioned generally upright so that the upper wall 121 is generally level. In other words, the descending portion 135 is closer to the fuel level within the tank 112 than the first line 123A is to the fuel level. Stated differently, the descending portion 135 extends generally away from the in-line liquid vapor discriminator trap 110 and further in the direction of the depth D of the fuel tank 112 than does the line 133. The T-connector 127 also operatively connects the line 129 to a conduit 133, also referred to herein as a vapor vent line, with an internal passage 134 that is in fluid communication with an evaporative canister (not shown). Accordingly, a vacuum in the line 129 can cause purging of the canister through line 133, drawing vapors to the engine.

A first end 130A, also referred to as an end wall, can be coupled to the housing 120A such as by welding. The housing 120A also has a second end or end wall 139A. As shown in FIG. 16, openings 164 extend through the end walls 130A, 139A, such as to receive fasteners to allow the liquid vapor discriminator trap 110A to be mounted relative to the tank 112 and the floor pan 153, such as by mounting brackets or the like. The outlet 126A extends through the end wall 139A. The housing 120A includes a generally cylindrical wall 141A. The inlet 140A extends through the first end or end wall 130A. As shown in greater detail in FIG. 16, the end wall 130A has a passage 160 that opens at opening 162 into a generally annular outer vapor space 150A of the in-line liquid vapor discriminator trap 110A.

A membrane filter 144A is positioned in the housing 120A. The membrane filter 144A can inhibit liquid fluid from passing from the first line 123A and the inlet 140A to the outlet 126A and the lines 129 and 133 downstream in vapor flow from the filter 144A. The filter 144A can be an oleophobic filter membrane that can prevent liquid from passing through the in-line liquid vapor discriminator trap 110A from the inlet 140A to the outlet 126A. The membrane filter 144A is also referred to herein as a membrane.

In the embodiment shown, the membrane filter 144A is generally columnar and has a center axis 143A that is the same as the center axis of the generally cylindrical wall 141A. As indicated by the center axis 143A, the filter 144A is positioned generally horizontally or sideways relative to the fuel tank 112, so that the center axis 143A is generally parallel with the upper wall 121 of the tank 112. In other words, the filter 144A and housing 120A are positioned to lay or extend generally lengthwise above the upper wall 121. The generally cylindrical wall 141A could be seated directly on the upper wall 122 with the inlet 140A fitting in a recess or valley, or over an edge of the upper wall 121. The entire liquid vapor discriminator trap 110A fits in the relatively small packaging space between a floor pan 153 of the vehicle and the upper wall 121 of the tank 112. The liquid vapor discriminator trap 110A has no moving components. As such, the liquid vapor discriminator trap 110A is more amenable to a tight packaging space than, for example, a valve that requires a float, as there is very little vertical distance between the upper wall 121 of the tank 112 and the floor pan 153 to accommodate a moving float, and likely, a biasing spring for the float.

As shown in FIG. 16, the filter 144A is nonplanar, and has a plurality of peaks 170A and valleys 172A that increase the area of an external surface 145A of the filter 144A relative to a true cylindrical surface. In other embodiments, the filter 144A can be folded, pleated, can be a true cylindrical shape, a wedge shape, or any other shape configured to separate the inlet 140A from the outlet 126A when the filter 144 is positioned in the housing 120A. In one example, the filter 144A can be sealed to the end walls 130A, 139A.

The filter 144A divides an internal housing cavity 147A into a generally annular outer vapor space 150A, and a generally cylindrical inner vapor space 152A. The outer vapor space 150A can be referred to as an overflow ring, as the filter 144A will stop any liquid fuel that flows through the inlet 140A. The inlet 140A is positioned relatively low in the housing 120A to encourage the liquid to drain back to the fuel tank 112 through the line 123A and valve 142.

FIGS. 17-20 show another embodiment of an in-line liquid vapor discriminator trap 110B for use in the system 119A in lieu of in-line liquid vapor discriminator trap 110A, and alike in all aspects to in-line liquid vapor discriminator trap 110A except with respect to the position of the inlet 140B in the end wall 130A, and the dimensions of the generally cylindrical wall 141B and the membrane filter 144B. The trap 110B can generally include a housing 120B that defines an inlet 140B, also referred to as an inlet port, and an outlet 126B, also referred to as an outlet port. A first end 130B, also referred to as an end wall, can be coupled to the housing 120B such as by welding. The housing 120B also has a second end or end wall 139B. Openings 164 extend through the end walls 130B, 139B, such as to receive fasteners to allow the liquid vapor discriminator trap 110B to be mounted relative to the tank 112 and the floor pan 153, such as by mounting brackets or the like. The outlet 126B extends through the end wall 139B. The housing 120B includes a generally cylindrical wall 141B. The inlet 140B extends through the first end or end wall 130B. The end wall 130B has a passage 160B that opens at opening 162 into a generally annular outer vapor space 150B of the in-line liquid vapor discriminator trap 110A.

A membrane filter 144B is positioned in the housing 120B. The membrane filter 144B can inhibit liquid fluid from passing from the first line 123A of FIG. 14 and the inlet 140B to the outlet 126B and the lines 129 and 133 downstream in vapor flow from the filter 144B. The filter 144B can be an oleophobic filter membrane that can prevent liquid from passing through the in-line liquid vapor discriminator trap 110B from the inlet 140B to the outlet 126B. The membrane filter 144B is also referred to herein as a membrane.

In the embodiment shown, the filter 144B is generally columnar and has a center axis 143B (shown in FIG. 20) that is the same as the center axis of the generally cylindrical wall 141B. The filter 144B can be positioned either generally upright, like filter 144 of FIGS. 12 and 13, so that center axis 144B is generally perpendicular to the upper wall 121 of the fuel tank 112, or can extend generally horizontally or sideways relative to the fuel tank 112, so that the center axis 143B is generally parallel with the upper wall 121 of the tank 112. In other words, the filter 144B and housing 120B can be positioned to lay or extend generally lengthwise above the upper wall 121. The generally cylindrical wall 141B could be seated directly on the upper wall 122 with the inlet 140B fitting in a recess or valley, or over an edge of the upper wall 121. The entire liquid vapor discriminator trap 110B fits in the relatively small packaging space between a floor pan 153 of the vehicle and the upper wall 121 of the tank 112. The valve 110B has no moving components. As such, the liquid vapor discriminator trap 110B is more amenable to a tight packaging space than, for example, a valve that requires a float, as there is very little vertical distance between the upper wall 121 of the tank 112 and the floor pan 153 to accommodate a moving float, and likely, a biasing spring for the float.

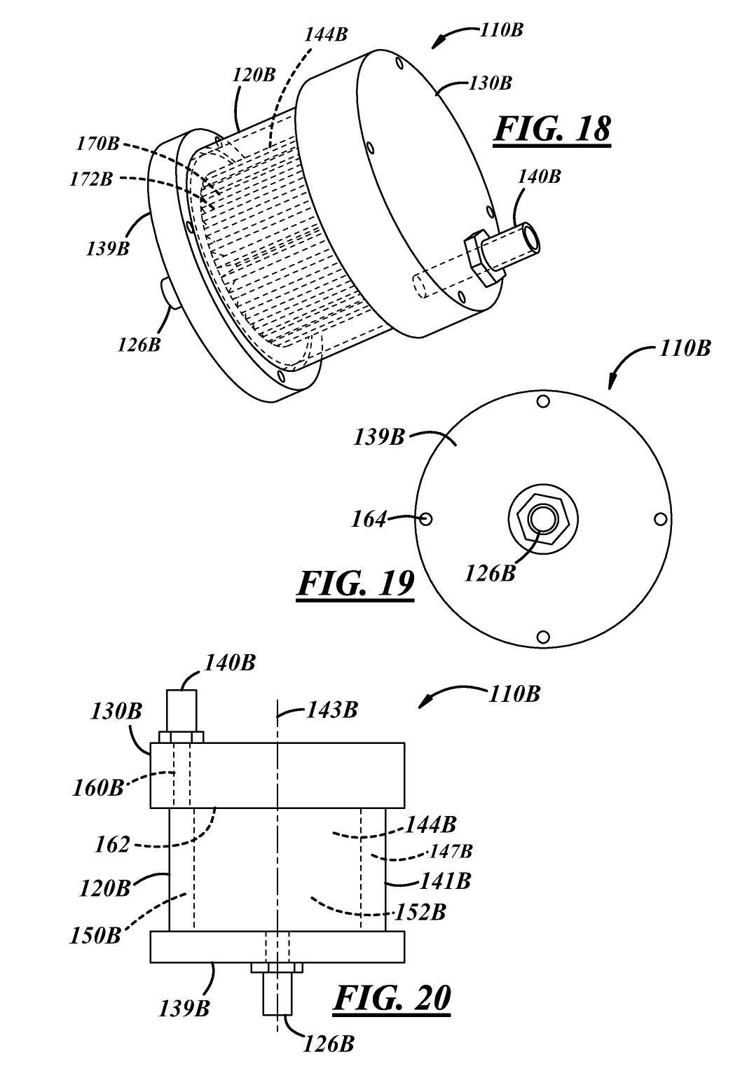

As shown in FIGS. 17 and 18, the filter 144B is nonplanar, and has a plurality of peaks 170B and valleys 172B that increase the area of the external surface 145B of the filter 144B relative to a true cylindrical surface. In other embodiments, the filter 144B can be folded, pleated, can be a true cylindrical shape, a wedge shape, or any other shape configured to separate the inlet 140B from the outlet 126B when the filter 144B is positioned in the housing 120B. In one example, the filter 144B can be sealed to the end walls 130B, 139B.

The filter 144B divides an internal housing cavity 147B into a generally annular outer vapor space 150B, and a generally cylindrical inner vapor space 152B. The outer vapor space 150B can be referred to as an overflow ring, as the filter 144B will stop any liquid fuel that flows through the inlet 140B. The inlet 140B is positioned relatively low in the housing 120B to encourage the liquid to drain back to the fuel tank 112 through the line 123A and valve 142.

While the best modes for carrying out the many aspects of the present teachings have been described in detail, those familiar with the art to which these teachings relate will recognize various alternative aspects for practicing the present teachings that are within the scope of the appended claims.

1. A system comprising:
a liquid containment tank having an interior space;
a first conduit external to and operatively connected with the tank;
wherein the first conduit has a first internal passage fluidly communicable with the interior space;
a second conduit;
a liquid vapor discriminating (LVD) valve external to the tank and having:
a housing defining an inlet connected to the first conduit, an outlet connected to the second conduit, and an internal housing cavity;
a membrane filter positioned in the internal housing cavity between the inlet and the outlet; and wherein the membrane filter is configured to prevent the passage of liquid through the membrane from the inlet to the outlet and allow the passage of vapor through the membrane from the inlet to the outlet.

2. The system of claim 1, wherein the inlet of the housing is configured so that liquid in the housing that is prevented from passing through the membrane filter drains back to the tank through the first conduit.

3. The system of claim 1, wherein the membrane filter is generally columnar and divides the internal housing cavity into an outer vapor space surrounding an exterior surface of the membrane filter, and an inner vapor space surrounded by the membrane filter; and
wherein the inlet is in communication with the outer vapor space and the outlet is in communication with the inner vapor space.

4. The system of claim 3, wherein the housing is generally cylindrical with a center axis extending through the inner vapor space.

5. The system of claim 4, wherein the housing has a generally cylindrical wall and has end covers connected to ends of the cylindrical wall to enclose the internal housing cavity;
wherein the outlet extends through one of the end covers generally parallel with the center axis; and
wherein the inlet extends through the generally cylindrical wall.

6. The system of claim 5, wherein the inlet is positioned nearer to the fuel tank than the outlet.

7. The system of claim 4, wherein the housing has a generally cylindrical wall defining the center axis and has end covers connected to ends of the cylindrical wall to enclose the internal housing cavity; and
wherein the inlet extends through the generally cylindrical wall.

8. The system of claim 4, wherein the generally columnar membrane is positioned generally lengthwise adjacent a wall of the tank so that the center axis is generally parallel with the upper wall of the tank.

9. The system of claim 4, wherein the generally columnar membrane is positioned generally upright above an upper wall of the tank so that the center axis is generally perpendicular to the upper wall of the tank.

10. The system of claim 9, wherein the outlet extends generally parallel with the wall of the tank from the inner housing cavity.

11. The system of claim 1, wherein the LVD valve has no moving components.

12. The fuel system of claim 1, wherein the membrane filter has a nonplanar surface.

13. The fuel system of claim 1, wherein the second conduit is external to the tank; wherein the second conduit has a second internal passage at least a portion of which extends further in a direction of a depth of the fuel tank than does the first internal passage.

14. A liquid vapor discriminator (LVD) trap configured for use with a tank and with a series of vapor venting conduits external to and operatively connected with the tank, at least one of the conduits having a descending portion that extends in a direction of a depth of the tank, the LDV trap comprising:
a housing defining an inlet and an outlet and configured to be connected in the series of vapor venting conduits such that vapor flows from the tank, then through the housing, and then to the descending portion; wherein the housing defines an internal housing cavity;
a membrane filter positioned in the internal housing cavity between the inlet and the outlet; and wherein the membrane filter is configured to prevent the passage of liquid through the membrane and allow the passage of vapor through the membrane.

15. The liquid vapor discriminator (LVD) trap of claim 14, wherein the inlet of the housing is configured so that liquid in the housing that is prevented from passing through the membrane filter drains through the inlet.

16. The liquid vapor discriminator (LVD) trap of claim 14, wherein the membrane filter is generally columnar and divides the internal housing cavity into an outer annular vapor space surrounding an exterior surface of the membrane filter, and an inner vapor space surrounded by the membrane filter; and
wherein the inlet is in communication with the outer annular vapor space and the outlet is in communication with the inner vapor space.

17. The liquid vapor discriminator (LVD) trap of claim 16, wherein the housing is generally cylindrical with a center axis extending through the inner vapor space.

18. The liquid vapor discriminator (LVD) trap of claim 17, wherein the housing has a generally cylindrical wall defining the center axis and has end covers connected to ends of the cylindrical wall to enclose the internal housing cavity;
wherein the outlet extends through one of the end covers generally parallel with the center axis; and
wherein the inlet extends through the generally cylindrical wall.

19. The liquid vapor discriminator (LVD) trap of claim 16, wherein the housing has a generally cylindrical wall defining the longitudinal center axis and has end covers connected to ends of the cylindrical wall to enclose the internal housing cavity; and
wherein the inlet extends through the generally cylindrical wall.

20. The liquid vapor discriminator (LVD) trap of claim 14, wherein the membrane filter has a nonplanar surface.
